(19) United States
(12) Patent Application Publication
(10) Pub. No.: US 2014/0021384 A1
(43) Pub. Date: Jan. 23, 2014

(54) ELECTRONICALLY CONTROLLED VALVE ASSEMBLY

(71) Applicants: Keith R. Kabel, Shelby Township, MI (US); Scott F. Shampine, Rochester Hills, MI (US); Peter J. Carleton, Rochester Hills, MI (US); Bipin D. Parekh, Plymouth, MI (US)

(72) Inventors: Keith R. Kabel, Shelby Township, MI (US); Scott F. Shampine, Rochester Hills, MI (US); Peter J. Carleton, Rochester Hills, MI (US); Bipin D. Parekh, Plymouth, MI (US)

(73) Assignee: GM GLOBAL TECHNOLOGY OPERATIONS LLC., Detroit, MI (US)

(21) Appl. No.: 13/554,208

(22) Filed: Jul. 20, 2012

(51) Int. Cl. F16K 31/02

(52) U.S. Cl. 251/129.01

(57) ABSTRACT

An electronically controlled valve assembly includes an electronically controlled linear actuator having a housing assembly and a rotor disposed within the housing assembly and controllably rotatable relative to the housing in response to a received motor control command. The rotor includes a drive shaft, and an annular bobbin circumferentially disposed about the drive shaft. The bobbin partially defines a receiving cavity between the bobbin and the drive shaft, and a first plurality of threads is disposed at an end portion of the drive shaft. The actuator further includes a stem that is rotationally stationary relative to the housing assembly, and which includes a second plurality of threads configured to cooperate with the first plurality of threads to translate the stem into the receiving cavity in response to the rotation of the rotor.

### TECHNICAL FIELD

The present invention relates generally to an electronically controlled valve assembly having a linear actuator configured to adjust fluid flow.

### BACKGROUND

Valves are commonly used in fluid flow systems to provide directional control of fluid flow. Many valves may selectively transition between an open (i.e., flowing) state and a closed (i.e., not flowing) state. Alternatively some valves may progressively meter the flow between the open and closed states. Valves may include two-way valves, controlling fluid flow with respect to an inlet and an outlet of the valve, or may be three-way, controlling fluid flow with respect to a pair of inlets and a single outlet of the valve or a pair of outlets and a single inlet of the valve.

### SUMMARY

An electronically controlled linear actuator includes a housing assembly, a rotor, and a stem. The rotor may be disposed within the housing assembly and oriented along a longitudinal axis. The rotor may be controllably rotatable relative to the housing assembly in response to a received motor control command, and may include a drive shaft and an annular bobbin. The drive shaft may have a first end portion, a second end portion, and may be disposed along the longitudinal axis. The annular bobbin may be circumferentially disposed about the drive shaft and coupled with the drive shaft at the first end portion. The bobbin may partially define a receiving cavity between the bobbin and the drive shaft. A first plurality of threads may be disposed on the second end portion of the drive shaft.

The stem may be disposed along the longitudinal axis and may be rotationally stationary relative to the housing assembly. The stem may define a cylindrical recess and may include a second plurality of threads about the cylindrical recess. During operation, the first plurality of threads and the second plurality of threads may cooperate to translate the stem into the receiving cavity in response to the rotation of the rotor.

In one configuration, the rotor may further include a plurality of motor windings disposed about the bobbin; and the housing assembly may include a permanent magnet disposed radially outward from the plurality of motor windings. In another configuration, the rotor may include a permanent magnet disposed about the bobbin, and the housing assembly may include a plurality of motor windings disposed radially outward from the permanent magnet.

A needle bearing assembly may be disposed between the rotor and the housing assembly to reduce friction. Likewise, at least one of a thrust bearing and a PTFE washer may be disposed between the rotor and the housing assembly.

The linear actuator may be used in conjunction with an electronically controlled valve assembly that further includes a valve body, a valve head, and a valve stem. The valve body may define a first valve seat and a second valve seat, wherein the first valve seat and second valve seat are disposed along the longitudinal axis and separated by a distance. The valve head may be disposed within the valve body and may be selectively translatable along the longitudinal axis throughout the distance between the first valve seat and the second valve seat. The valve stem may have a first end portion and a second end portion and may be disposed along the longitudinal axis. The valve stem may be coupled with the valve head at the first end portion.

The electronically controlled linear actuator may be coupled with the valve body and may be configured to selectively translate the valve head and valve stem in response to a received motor control command.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a fluid valve including a sealed, electronically controlled linear actuator.

FIG. 2 is a schematic cross-sectional view of an embodiment of the fluid valve of FIG. 1.

FIG. 3 is an enlarged schematic cross-sectional view of the linear actuator of FIG. 2.

FIG. 4 is a schematic cross-sectional view of an embodiment of the fluid valve of FIG. 1.

FIG. 5 is an enlarged schematic cross-sectional view of the linear actuator of FIG. 4.

### DETAILED DESCRIPTION

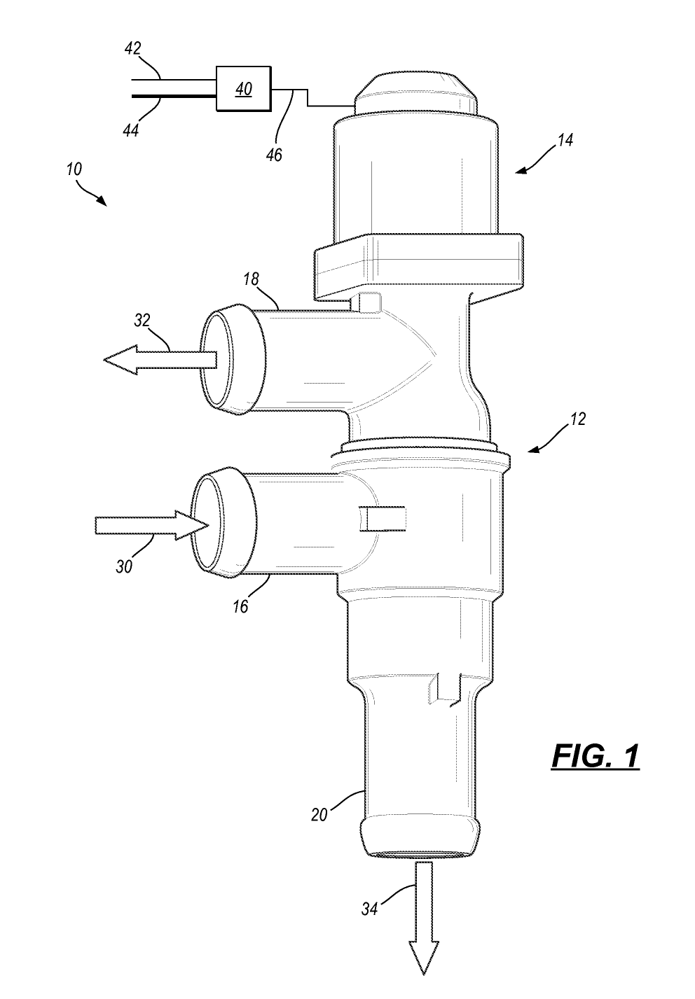

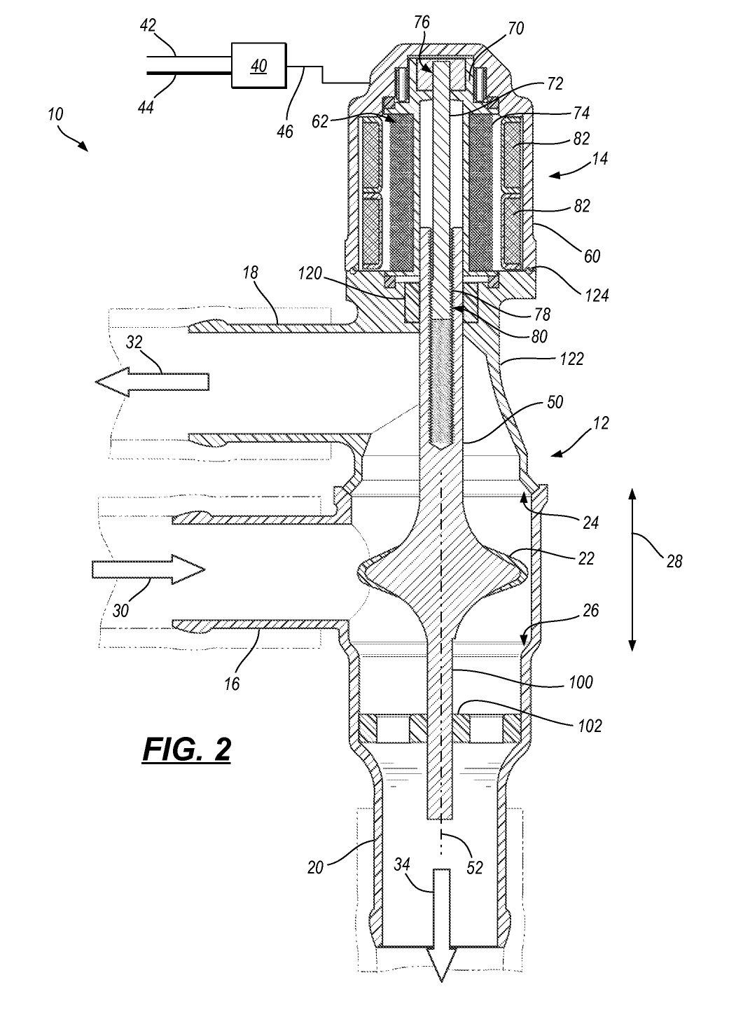

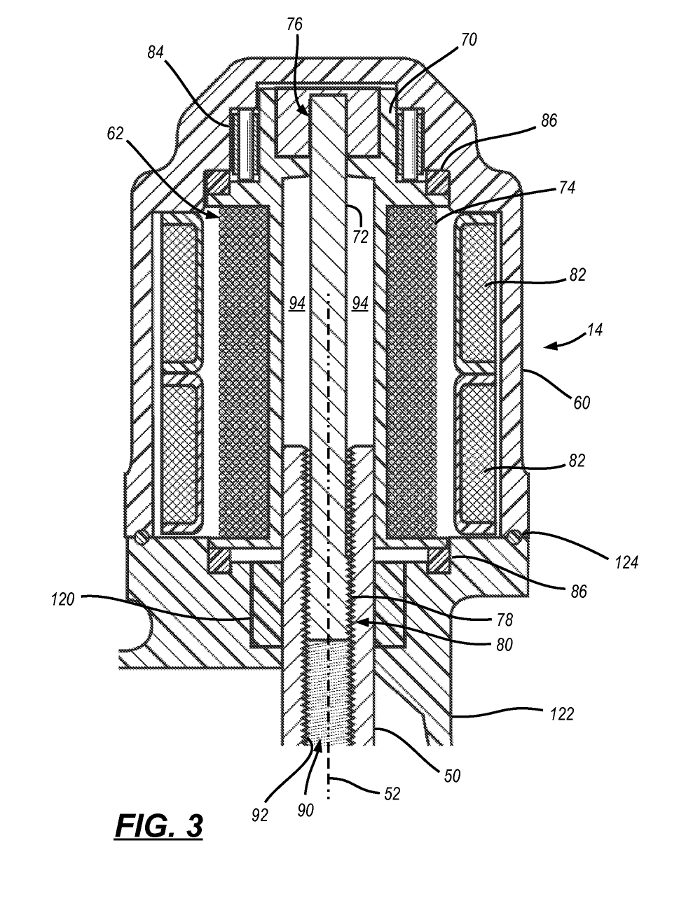

Referring to the drawings, wherein like reference numerals are used to identify like or identical components in the various views, FIG. 1 schematically illustrates an electronically controlled valve 10 that may generally include a valve body 12 and an electronically controlled linear actuator 14 (i.e., electronic actuator 14). The valve 10 may be, for example, a three-way valve (as shown) that may be characterized by three, distinct fluid ports 16, 18, 20. Alternatively, in other configurations, the valve 10 may be a two-way valve (i.e., having only two ports) or may be a four or more-way valve (i.e., having four or more ports). Further detail of the valve 10 can be seen from the cross-sectional views provided in FIGS. 2 and 3.

As generally shown in FIG. 2, the electronic actuator 14 may be configured to continuously modulate fluid flow between any two respective ports by translating a valve head 22 between two seated positions 24, 26 within the valve body 12. This valve head 22 motion (along direction 28) may, for example, selectively modulate/divert an inlet fluid flow 30 between the two outlet ports 18, 20 (i.e., outlet flows 32, 34, respectively). It should be appreciated that the specific fluid flows shown in FIGS. 1-2 are provided for illustrative purposes and should not be limiting. In practice, any particular port may be used as either an inlet or outlet (provided that there is at least one inlet and at least one outlet among the various ports).

The valve 10 may further include, or be in communication with a motor controller 40 that may selectively control and/or monitor the actuation of the electronic actuator 14. In one configuration the motor controller 40 may receive an actuation control signal 42 and an electrical power supply 44 from a supervisory system (not shown), and may selectively provide a motor control signal 46 to the actuator 14. In one configuration, the motor controller 40 may be similar to a stepper motor controller. In another configuration, the motor controller 40 may include control logic, and may be embodied as one or multiple digital computers or data processing devices, having one or more microcontrollers or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, and/or signal conditioning and buffering electronics.

Referring still to FIG. 2, in one configuration, the movable valve head 22 may be rigidly coupled with a valve stem 50, which may generally be disposed along a longitudinal axis 52. The valve stem 50 may be in mechanical communication with the electronic actuator 14 such that the actuator 14 may translate the stem 50 and head 22 along the longitudinal axis 52.

The electronic actuator 14, which is more clearly illustrated in FIG. 3, may include a substantially fixed housing assembly 60 and a driven component 62 (also referred to as a “rotor 62”). The rotor 62 may be disposed within the housing assembly 60 and oriented along the longitudinal axis 52. The rotor 62 may controllably rotate relative to the housing assembly 60 to translate the stem 50 and valve head 22 in response to a received motor control command/signal 46. In one configuration, the rotor 62 may include a bobbin 70, a drive shaft 72, and a plurality of motor windings 74 disposed about the bobbin 70. The bobbin 70 may have a substantially annular shape, and may be circumferentially disposed about the drive shaft 72 and coaxially aligned with the drive shaft 72 along the longitudinal axis 52. The drive shaft 72 may be fixed to the bobbin 70 at a first end 76, and may include a plurality of channels, grooves, or threads 78 at a second end 80.

The housing assembly 60 may partially surround the rotor 62, and may include one or more permanent magnets 82 disposed radially outward from the plurality of motor windings 74. In this manner, by supplying an electrical current through the plurality of motor windings 74, the rotor 62 may rotate relative to the housing 60 (i.e., in response to the received motor control signal 46). To reduce the static and/or dynamic friction between the bobbin 70 and the housing 60, one or more bearings or washers may be employed. For example, as shown in FIG. 3, in one configuration a needle bearing assembly 84 may be disposed proximate the first end 76 of the drive shaft 72, between the bobbin 70 and the housing assembly 60. The needle bearing 84 may promote smooth rotational motion of the rotor 62, while generally centering the rotor 62 within the housing 60. Additionally, one or more thrust bearings and or Polytetrafluoroethylene (PTFE) washers 86 may be disposed along the longitudinal axis 52 to similarly reduce contact friction between the bobbin 70 and the housing 60.

In one configuration, the valve stem 50 may define a cylindrical recess 90 disposed along the longitudinal axis 52. The valve stem 50 may further define a plurality of channels, grooves, or threads 92 about the cylindrical recess 90 (i.e., internal threads 92). The internal threads 92 of the valve stem 50 may cooperate with the corresponding threads 78 of the drive shaft 72 to translate the valve stem 50 along the longitudinal axis 52 in response to a rotation of the rotor 62.

To ensure that the valve stem 50 translates, rather than merely rotating with the rotor 62 it may be constrained from rotation relative to the actuator housing 60 and valve body 12. Referring again to FIG. 2, in one configuration, the rotational constraint may be accomplished by providing a flat surface 100 or similar keyed feature that may engage with a matching profile in the valve body 12 or guide member 102. For example, the valve stem 50 may have a D-shaped cross-sectional profile, and the guide member 102 may include a similar “D”-shaped opening configured to receive the valve stem 50.

Referring again to FIG. 3, the rotor 62 may define a receiving cavity 94 between the bobbin 70/motor windings 74 and the drive shaft 72. The receiving cavity 94 may be configured to accept the valve stem 50 as it is controllably translated into the actuator assembly 14.

As can be seen from the various drawings, the electronic actuator 14 may be a direct-drive actuator that does not utilize intermediate gearing to increase the mechanical advantage of the motor. Rather, the mechanical advantage may largely be a product of the pitch of the screw threads (i.e., threads 78, 92) of the drive shaft 72 and valve stem 50. To decrease contact friction at the thread interface, instead of a lead-screw-type design, another configuration may employ ball-bearings between the drive shaft 72 and valve stem 50, similar to a ball-screw.

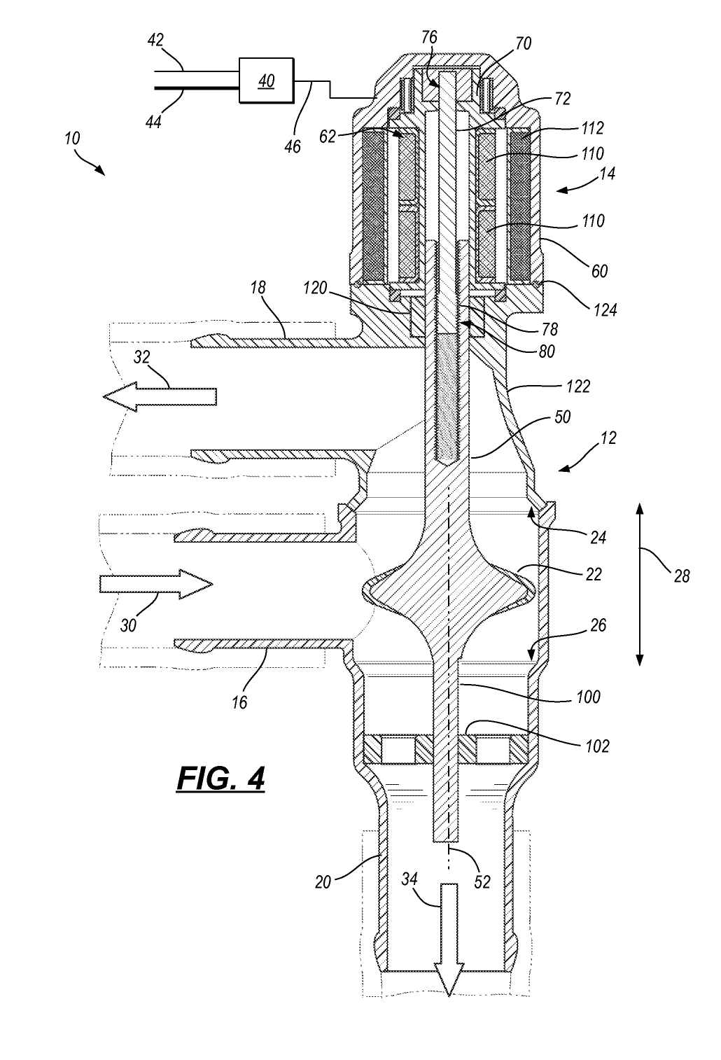

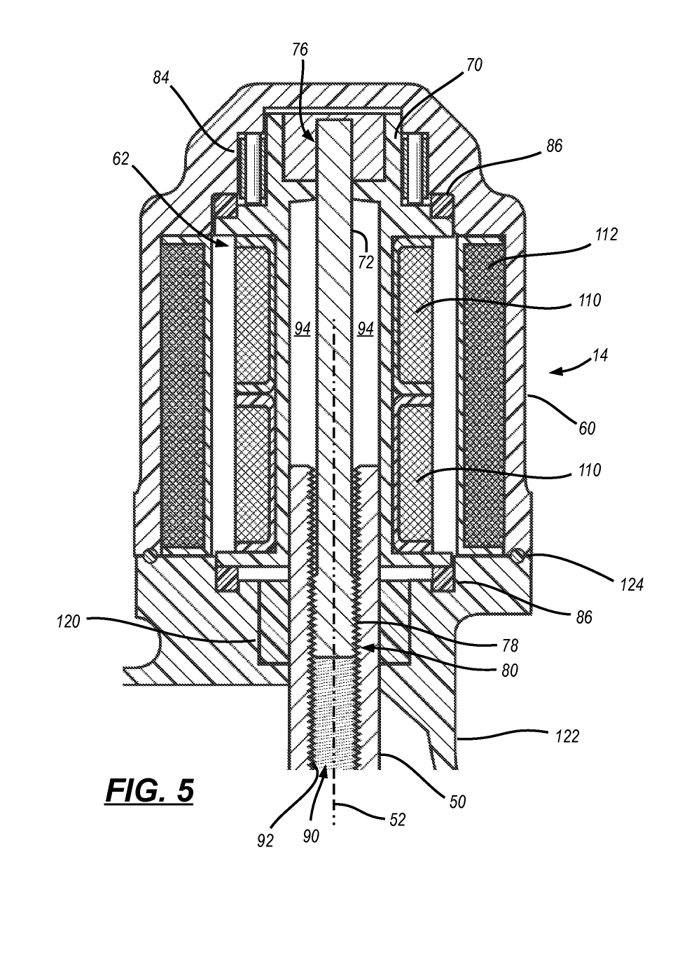

FIGS. 4-5 illustrate another configuration of the electronic actuator 14. As shown, the actuator 14 may be similar to a brushless motor, where a plurality of permanent magnets 110 are disposed on the rotor 62, while a plurality of motor windings 112 are disposed on the motor housing 60 in a radially outward direction from the permanent magnets 110. In this manner, the complexity of the actuator 14 may be reduced due to the eliminated need to supply electrical current to the rotating rotor 62.

Referring again to FIG. 2, the electronic actuator 14 may be fluidly isolated from both the valve body 12 and from the external environment by one or more elastomeric seals. For example, in one configuration, a first elastomeric seal 120 may be disposed within a portion of the valve body 12 between a wall 122 of the valve body 12 and the translatable valve stem 50. In this manner, the elastomeric seal 120 may be held in compression, and may prevent fluid from flowing into the actuator housing 60 from the valve body 12. Likewise, a second elastomeric seal 124 may be disposed between the actuator housing 60 and the wall 122 of the valve body 12. This second seal 124 may prevent fluid from the surrounding environment from passing into the actuator housing 60.

The present valve assembly 10 may permit a continuously variable flow diversion between the first outlet port 18 and the second outlet port 20. By controllably rotating rotor 62 and corresponding drive shaft 72, the motor controller 40 may position the valve head 22 at any point along the distance 28 between the first seated position 24 and the second seated position 26. As may be appreciated, if the valve head 22 is in contact with the wall 122 of the valve body 12 at the first seated position 24, the entirety of the inlet flow 30 may pass through the second outlet port 20. Conversely, if the valve head 22 is in contact with the wall 122 of the valve body 12 at the second seated position 26, the entirety of the inlet flow 30 may pass through the first outlet port 18. Finally, if the valve head 22 is disposed between the first seated position 24 and the second seated position 26, the outlet flows 32, 34 through the respective first and second outlet ports 18, 20 may be a function of the position of the valve head 22, together with the relative pressures of the systems coupled with the respective outlet ports 18, 20. In this manner, by continuously modulating the position of the valve head 22 within the valve body 12 between the first and second seated positions 24, 26, the valve controller 40 may selectively provide more or less fluid flow through each of the respective outlet ports 18, 20.

In one configuration, the electronic actuator 14 may include an absolute encoder that may provide the motor controller 40 with an indication of the absolute position of valve head 22 between the respective first and second seated positions 24, 26. This position may be resolved by, for example, monitoring the position of the valve stem 50 relative to the actuator 14. Alternatively, in another configuration, the valve controller 40 may include a relative encoder that may provide an indication of the relative rotation of the rotor 62 in response to the commanded position (i.e., position commanded via the motor control signal 46). If a relative encoder (or no-encoder) is used to resolve actual motion in response to commanded motion, an initialization routine may be first performed by the controller 40 to establish a zero-position from which all relative motion may be based. In one configuration, the initialization routine may include translating the valve head in a first linear direction until it is halted at one of the first or second seated positions 24, 26.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. An electronically controlled linear actuator comprising:
a housing assembly;
a rotor disposed within the housing assembly and oriented along a longitudinal axis, the rotor being controllably rotatable relative to the housing assembly in response to a received motor control command, the rotor including:
a drive shaft having a first end portion and a second end portion, and disposed along the longitudinal axis;
an annular bobbin circumferentially disposed about the drive shaft and coupled with the drive shaft at the first end portion, the bobbin partially defining a receiving cavity between the bobbin and the drive shaft; and
a first plurality of threads disposed on the second end portion of the drive shaft;
a stem disposed along the longitudinal axis and being rotationally stationary relative to the housing assembly, the stem defining a cylindrical recess and including a second plurality of threads about the cylindrical recess; and
wherein the first plurality of threads and the second plurality of threads cooperate to translate the stem into the receiving cavity in response to the rotation of the rotor.

2. The linear actuator of claim 1, wherein the rotor further includes a plurality of motor windings disposed about the bobbin; and
wherein the housing assembly includes a permanent magnet disposed radially outward from the plurality of motor windings.

3. The linear actuator of claim 1, wherein the rotor further includes a permanent magnet disposed about the bobbin; and
wherein the housing assembly includes a plurality of motor windings disposed radially outward from the permanent magnet.

4. The linear actuator of claim 1, further comprising a needle bearing disposed between the rotor and the housing assembly; and
at least one of a thrust bearing and a PTFE washer disposed between the rotor and the housing assembly.

5. An electronically controlled valve assembly comprising:
a valve body defining a first valve seat and a second valve seat, the first valve seat and second valve seat being disposed along a longitudinal axis and separated by a distance;
a valve head disposed within the valve body and being selectively translatable along the longitudinal axis throughout the distance between the first valve seat and the second valve seat;
a valve stem having a first end portion and a second end portion and disposed along the longitudinal axis, the valve stem coupled with the valve head at the first end portion;
an electronically controlled linear actuator coupled with the valve body and configured to selectively translate the valve head and valve stem in response to a received motor control command, the electronic actuator including:
a housing assembly;
a rotor disposed along the longitudinal axis and within the housing assembly, the rotor configured to rotate relative to the housing assembly in response to the received motor control command; and
wherein the rotor is configured to cooperate with the second end portion of the valve stem to translate the valve stem and valve head along the longitudinal axis in response to the rotation of the rotor.

6. The valve assembly of claim 5, wherein the rotor includes:
a drive shaft having a first end portion and a second end portion, and disposed along the longitudinal axis;
an annular bobbin circumferentially disposed about the drive shaft and coupled with the drive shaft at the first end portion, the bobbin partially defining a receiving cavity between the bobbin and the drive shaft; and
wherein the second end portion of the drive shaft is configured to cooperate with the second end portion of the valve stem to translate the valve stem and valve head along the longitudinal axis in response to the rotation of the rotor.

7. The valve assembly of claim 6, wherein the drive shaft includes a first plurality of threads disposed about its second end portion;
wherein the second end portion of the valve stem includes a cylindrical recess having a second plurality of threads disposed about the recess; and
wherein the first plurality of threads and the second plurality of threads cooperate to translate the valve stem into the receiving cavity in response to the rotation of the rotor.

8. The valve assembly of claim 6, wherein the rotor further includes a plurality of motor windings disposed about the bobbin; and
wherein the housing assembly includes a permanent magnet disposed radially outward from the plurality of motor windings.

9. The valve assembly of claim 6, wherein the rotor further includes a permanent magnet disposed about the bobbin; and
wherein the housing assembly includes a plurality of motor windings disposed radially outward from the permanent magnet.

10. The valve assembly of claim 5, further comprising a needle bearing disposed between the rotor and the housing assembly; and
at least one of a thrust bearing and a PTFE washer disposed between the rotor and the housing assembly.

11. The valve assembly of claim 5, further comprising a first elastomeric seal disposed between the valve body and the valve stem, and a second elastomeric seal disposed between the housing assembly of the linear actuator and the valve body.

12. The valve assembly of claim 5, wherein the valve body further defines a first fluid port, a second fluid port and a third fluid port;
wherein each of the first, second, and third fluid ports are in selective fluid communication with the other respective fluid ports;
wherein movement of the valve head toward the first valve seat restricts the fluid communication between the first fluid port and the second fluid port; and
wherein movement of the valve head toward the second valve seat restricts the fluid communication between the first fluid port and the third fluid port.

13. An electronically controlled valve assembly comprising:
a valve body defining a first valve seat and a second valve seat, the first valve seat and second valve seat being disposed along a longitudinal axis and separated by a distance;
a valve head disposed within the valve body and being selectively translatable along the longitudinal axis throughout the distance between the first valve seat and the second valve seat;
a valve stem having a first end portion and a second end portion and disposed along the longitudinal axis, the valve stem coupled with the valve head at the first end portion;
an electronically controlled linear actuator coupled with the valve body and configured to selectively translate the valve head and valve stem in response to a received motor control command, the electronic actuator including:
a housing assembly;
a rotor disposed along the longitudinal axis and within the housing assembly, the rotor configured to rotate relative to the housing assembly in response to the received motor control command, the rotor including:
a drive shaft having a first end portion and a second end portion, and disposed along the longitudinal axis;
an annular bobbin circumferentially disposed about the drive shaft and coupled with the drive shaft at the first end portion, the bobbin partially defining a receiving cavity between the bobbin and the drive shaft; and
wherein the second end portion of the drive shaft is configured to cooperate with the second end portion of the valve stem to translate the valve stem and valve head along the longitudinal axis in response to the rotation of the rotor.

14. The valve assembly of claim 13, wherein the drive shaft includes a first plurality of threads disposed about its second end portion;
wherein the second end portion of the valve stem includes a cylindrical recess having a second plurality of threads disposed about the recess; and
wherein the first plurality of threads and the second plurality of threads cooperate to translate the valve stem into the receiving cavity in response to the rotation of the rotor.

15. The valve assembly of claim 13, wherein the rotor further includes a plurality of motor windings disposed about the bobbin; and
wherein the housing assembly includes a permanent magnet disposed radially outward from the plurality of motor windings.

16. The valve assembly of claim 13, wherein the rotor further includes a permanent magnet disposed about the bobbin; and
wherein the housing assembly includes a plurality of motor windings disposed radially outward from the permanent magnet.

17. The valve assembly of claim 13, further comprising a needle bearing disposed between the rotor and the housing assembly; and
at least one of a thrust bearing and a PTFE washer disposed between the rotor and the housing assembly.

18. The valve assembly of claim 13, further comprising a first elastomeric seal disposed between the valve body and the valve stem, and a second elastomeric seal disposed between the housing assembly of the linear actuator and the valve body.

19. The valve assembly of claim 13, wherein the valve body further defines a first fluid port, a second fluid port and a third fluid port;
wherein each of the first, second, and third fluid ports are in selective fluid communication with the other respective fluid ports;
wherein movement of the valve head toward the first valve seat restricts the fluid communication between the first fluid port and the second fluid port; and
wherein movement of the valve head toward the second valve seat restricts the fluid communication between the first fluid port and the third fluid port.
